(19) United States
(12) Patent Application Publication
(10) Pub. No.: US 2024/0211498 A1
(43) Pub. Date: Jun. 27, 2024

(54) EVALUATION SYSTEM AND EVALUATION METHOD

(71) Applicant: Hitachi, Ltd., Tokyo (JP)

(72) Inventors: Kazuyoshi KARATSUYA, Tokyo (JP); Yasuto NISHIWAKI, Tokyo (JP)

(21) Appl. No.: 18/534,826

(22) Filed: Dec. 11, 2023

(30) Foreign Application Priority Data
Dec. 23, 2022 (JP) 2022-206301

(51) Int. Cl. G06F 16/31

(52) U.S. Cl. CPC G06F 16/328

(57) ABSTRACT

To provide a computer system capable of evaluating a social value included in text data, it is provided an evaluation system for evaluating a predetermined index based on an input message being input text information, the evaluation system comprising: a calculation unit configured to execute calculation processing; and a storage unit accessible from the calculation unit, the calculation unit including: an analysis module configured to analyze the input message through use of a model that adds a label of sensitivity to the input message, to thereby categorize the input message; and an evaluation module configured to calculate correlation between a numerical value of each item included in a result of the analysis obtained by the analysis module and a predetermined index value.

### CLAIM OF PRIORITY

The present application claims priority from Japanese patent application JP 2022-206301 filed on Dec. 23, 2022, the content of which is hereby incorporated by reference into this application.

### BACKGROUND OF THE INVENTION

This invention relates to an evaluation system for evaluating text data from a viewpoint of sensitivity.

Communication using social media such as a blog and a social networking service has become widespread, and information is transmitted from general users (including persons transmitting opinions on webpages, SNSs, blogs, and the like on the Internet), companies, and local governments via the Internet. As a result, a large amount of text data is accumulated. In recent years, it has been considered to analyze such a large amount of accumulated text data to utilize analysis results for company activities, and accordingly, there has been desired a technology which efficiently extracts desired text data from the large amount of text data, and quantitatively analyzes or visualizes the extracted text data.

As a general method of acquiring desired information from a large amount of text data, a search such as a full-text search is used. In the full-text search, a keyword representing a characteristic of the text data desired by a user is usually specified for the search. However, it takes time for the user to examine an enormous amount of data collected through use of the keyword search from the large amount of text data to extract useful information.

Thus, a method of extracting texts closer to the information desired by the user is attracting attention, and many methods have been proposed. Examples of the methods include a method of identifying a related word from a synonym and a method of learning a distributed representation of a word of sentence analysis data for reference through machine learning to search for a similar sentence.

Moreover, a social value of each of a company and a local government is evaluated based on a predetermined evaluation index (for example, a rating or a population increase rate). In the rating and the like, there is a case in which a rating company does not disclose details of its evaluation criterion process, and hence it is not known whether or not evaluation of general potential users who possibly become users of a company or a local government and the like are reflected.

As the background art in this field, there is WO 2022/224352 A1. In WO 2022/224352 A1, there is described, as means for evaluating and identifying a social value of a company on various evaluation axes from text information delivered every day such as press releases, news releases, and SNSs transmitted by the company independently of published information published several times per year such as annual reports of the company, a social value evaluation device including a feature amount generation module which generates a feature amount from text information relating to evaluation of the social value, an input module which inputs text information relating to an evaluation target, an evaluation module which evaluates a relationship between the text information input by the input module and the feature amount, and an output module which outputs an evaluation result obtained by the evaluation module.

### SUMMARY OF THE INVENTION

As described above, various activities of the company or the local government can generally be evaluated based also on a numerical value appearing in the predetermined evaluation index. Meanwhile, results of decision-making by the general potential users who possibly become the users of the company or the local government often appear as numbers in a large portion of this information. Information relating to a process, such as sentiment (including negative and positive), images, problems, and evaluation held by the general users about the company or the local government, may be posted on the Internet in the course of the above-mentioned decision-making as less reserved information. However, although this information is useful for verification of appropriateness of measures taken by the company or the local government (whether or not the measures are correctly recognized and evaluated and whether or not the measures contribute to the increase in evaluation of the social value) and examination of points to be improved and measures to be additionally taken, and the like, but such information is not effectively used.

As the sense of value diversifies, a guideline for corporate actions may be obtained and specific improvement measures may be discovered in development of services and products by quantitatively and objectively analyzing the large amount of text data containing the opinions of the people. Thus, the analysis of the text data is important for the cooperate activities, but there is a problem in that the analysis cannot appropriately be executed without presence of a person holding specialized knowledge and experience.

An object of this invention is to provide a computer system capable of evaluating a social value included in text data.

The representative one of inventions disclosed in this application is outlined as follows. There is provided an evaluation system for evaluating a predetermined index based on an input message being input text information, the evaluation system comprising: a calculation unit configured to execute calculation processing; and a storage unit accessible from the calculation unit, the calculation unit including: an analysis module configured to analyze the input message through use of a model that adds a label of sensitivity to the input message, to thereby categorize the input message; and an evaluation module configured to calculate correlation between a numerical value of each item included in a result of the analysis obtained by the analysis module and a predetermined index value.

According to the at least one aspect of this invention, it is possible to appropriately evaluate the social value included in text information. Problems, configurations, and effects other than those described above become apparent through the following description of at least one embodiment.

### BRIEF DESCRIPTION OF THE DRAWINGS

FIG. 1 is a diagram for illustrating a logical configuration of an ESG evaluation system according to an embodiment of this invention.

FIG. 2 is a diagram for illustrating a physical configuration of the ESG evaluation system according the hte embodiment of this invention.

FIG. 3 is a flowchart of processing executed by the ESG evaluation system according to the embodiment of this invention.

FIG. 4 is a diagram for illustrating sensitivity analysis data according to the embodiment of this invention.

FIG. 5 is a diagram for illustrating sensitivity analysis data according to the embodiment of this invention.

FIG. 6 is a diagram for illustrating sensitivity analysis data according to the embodiment of this invention.

FIG. 7 is a diagram for illustrating an output example of the ESG evaluation system according to the at least one embodiment of this invention.

FIG. 8 is a diagram for illustrating an output example of the ESG evaluation system according to the embodiment of this invention.

FIG. 9 is a diagram for illustrating an output example of the ESG evaluation system according to the embodiment of this invention.

FIG. 10 is a diagram for illustrating an output example of the ESG evaluation system according to the embodiment of this invention.

FIG. 11 is a diagram for illustrating an output example of the ESG evaluation system according to the embodiment of this invention.

### DETAILED DESCRIPTION OF THE PREFERRED EMBODIMENTS

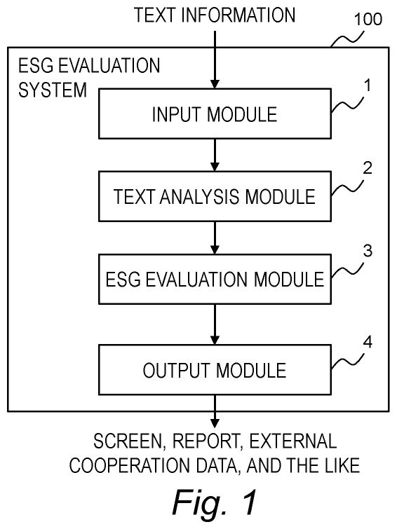

FIG. 1 is a diagram for illustrating a logical configuration of an ESG evaluation system 100 according to an embodiment of this invention.

The ESG evaluation system 100 according to the at least one embodiment includes an input module 1, a text analysis module 2, an ESG evaluation module 3, and an output module 4.

The input module 1 receives input of a set of pieces of text information (for example, data on messages of SNSs transmitted by general users and a specific company or local government) to be analyzed. This text information is collected by crawling the Internet based on specific keywords. A company name and an abbreviation thereof (for example, Hitachi, Ltd. and Hitachi) may be set to the keywords used to collect the messages being the text information, to thereby collect messages relating to a specific company or company group. Moreover, a plurality of words relating to a specific theme may be set, to thereby collect messages relating to this specific theme. For example, keywords relating to the environment, such as greenhouse effect gas, marine pollution, climate change, COP, ecological system, global warming, carbon neutral, and renewable energy, may be set to collect messages having the environment as the theme. Moreover, messages may be collected from a specific SNS (Twitter, Instagram, Facebook, or the like).

The text analysis module 2 analyzes the input messages, categorizes the messages into items, and sums the number of messages in each category. The summation by the text analysis module 2 includes calculation of statistical values of the analysis result such as a positive/negative total value described later. The text analysis module 2 may be formed of a machine learning model which has learned through use of messages labeled based on keywords representing sensitivity, or a mathematical model which categorizes the message based on keywords associated with the sensitivity. The text analysis module 2 uses those models to label the input message with the keywords representing the sensitivity.

Moreover, the text analysis module 2 may include a machine learning model which has learned through use of messages labeled based on keywords representing moral, or a mathematical model which categorizes the message based on keywords associated with the moral. The text analysis module 2 uses those models to label the input message with the keywords representing the moral.

Moreover, the text analysis module 2 may include a machine learning model which has learned through use of messages labeled based on keywords representing a field indicating characteristics and attributes of companies, or a mathematical model which categorizes the message based on keywords associated with this field. In other words, the text analysis module 2 uses those models to label the input message with the keywords representing the field.

It is preferred that the machine learning model forming the text analysis module 2 output certainty of the analysis result (value of each item). The certainty is used to weight numbers of messages being the analysis result as described later.

The text analysis module 2 may include all of the above-mentioned models, or may include one or more models of the plurality of models. That is, the text analysis module 2 is only required to label the input message based on any one of the sensitivity, the moral, the field, or the word. Moreover, those models may be formed as one model, or may be formed as individual models.

In the at least one embodiment, “sensitivity” means capability of sensing a sense of another person as if this sense were his or her own sense, and conveying this sense to still other persons, and sensitivity analysis by the text analysis module 2 broadly categorizes the message into large categories including three sensitivity levels (positive, neutral, and negative) and no sensitivity, and further categorizes the message into small categories. “No sensitivity” is a label indicating that the message cannot be categorized into any sensitivity level. The large categories and the small categories of the sensitivity are exemplified below.

### Large Category: Positive (Good)

Small categories: happy, relief, fun, good description, quick response, praise/applause, want to buy, reputation/popularity, good tasting, and the like

### Large Category: Neutral

Small categories: request, question, proposal/advice, and the like

### Large Category: Negative (Bad)

Small categories: anger, discontent, sad, uneasy, slow response, harassment, slander/libel, discontent with amount of money, not selling well, bad tasting, and the like

Moreover, in the at least one embodiment, “moral” means a way of thinking and an action following a right principle which the human is to follow to act, and is a concept based on the moral foundations theory proposed by Jonathan Haidt, who is a social psychologist. In the moral foundations theory, the moral is categorized into six moral foundations (care, fairness, ingroup, authority, purity, and general) being basic categories, and each moral foundation is categorized into “virtue” and “vice” of the moral.

The ESG evaluation module 3 calculates correlation of an analysis result output by the text analysis module 2 with an ESG score. The ESG score is an index for evaluating a company from viewpoints of environment, social, and governance. The ESG evaluation module 3 may calculate correlation with, in addition to the ESG score, a rating increase value, a rating, an ESG score, an SDGs evaluation ranking increase degree, and an SDGs evaluation ranking, and a population increase rate, a hometown tax donation amount, and the like for the local government.

The output module 4 outputs an analysis result relating to a characteristic of the text set found from the analysis result of the texts and the calculated correlation. The output module 4 can output the analysis result in various forms such as screen display data, print data for printing a report on paper, and external cooperation data to be transmitted to another system.

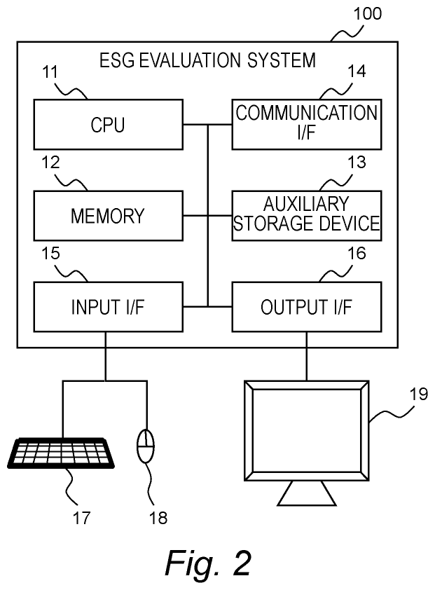

FIG. 2 is a diagram for illustrating a physical configuration of the ESG evaluation system 100 according the embodiment of this invention.

The ESG evaluation system 100 is formed of a computer which includes a processor (CPU) 11, a memory 12, an auxiliary storage device 13, and a communication interface 14. The ESG evaluation system 100 may include an input interface 15 and an output interface 16.

The processor 11 is a calculation device which executes programs stored in the memory 12. Functions provided by the respective function modules (for example, the input module 1, the text analysis module 2, ESG evaluation module 3, the output module 4, and the like) of the ESG evaluation system 100 are implemented by the processor 11 executing the various programs. A part of processing executed by the processor 11 executing the program may be executed by another calculation device (for example, hardware such as an ASIC and an FPGA).

The memory 12 includes a ROM which is a nonvolatile memory device and a RAM which is a volatile memory device. The ROM stores an invariable program (for example, BIOS) and the like. The RAM is a high-speed and volatile memory device such as a dynamic random access memory (DRAM), and temporarily stores the program to be executed by the processor 11 and data used when the program is executed.

The auxiliary storage device 13 is a high-capacity and nonvolatile storage device such as a magnetic storage device (HDD) and a flash memory (SSD). Moreover, the auxiliary storage device 13 stores the data used when the processor 11 executes the program and the program to be executed by the processor 11. That is, the program is read out from the auxiliary storage device 13, is loaded on the memory 12, and is executed by the processor 11, to thereby implement each function of the ESG evaluation system 100.

The communication interface 14 is a network interface device which controls communication to and from other devices (for example, a computer system to which output data is to be output for external cooperation) in accordance with a predetermined protocol.

The input interface 15 is an interface to which input devices such as a keyboard 17 and a mouse 18 are coupled and which receives input from an operator. The output interface 16 is an interface to which output devices such as a display device 19 and a printer (not shown) are coupled, and which outputs an execution result of the program in a form that allows the operator to visually recognize the execution result. A terminal coupled via a network may provide the input interface 15 and the output interface 16.

The program executed by the processor 11 is provided to the ESG evaluation system 100 through a removable medium (such as a CD-ROM and a flash memory) or the network, and is stored in the non-volatile auxiliary storage device 13 being a non-transitory storage medium. Thus, it is preferred that the ESG evaluation system 100 have an interface for reading data from the removable medium.

The ESG evaluation system 100 is a computer system implemented on physically one computer or implemented on a plurality of computers that are configured logically or physically, and may operate on a virtual machine built on a plurality of physical computer resources. For example, each of the input module 1, the text analysis module 2, the ESG evaluation module 3, and the output module 4 may operate on a separate physical or logical computer, or a plurality of those modules may be combined to operate on one physical or logical computer.

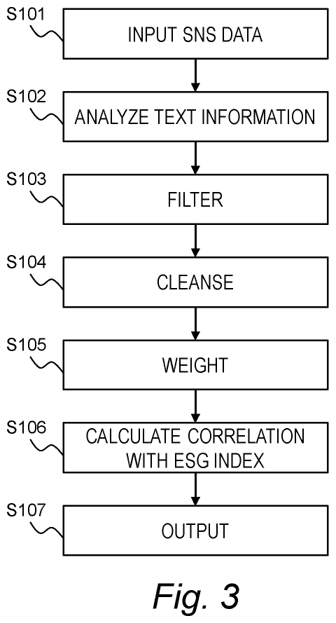

FIG. 3 is a flowchart of processing executed by the ESG evaluation system 100 according to the embodiment of this invention.

First, the input module 1 receives the input of the set of the messages (data on messages of SNSs transmitted by general users and specific companies and local governments) (S101).

Next, the text analysis module 2 analyzes the input messages, categorizes the messages in accordance with the sensitivity of creators expressed in the messages, and sums the number of corresponding messages for each category item (S102). Each of the messages is only required to be labeled based on any one of the above-mentioned sensitivity, moral, field, and word, thereby being categorized.

Next, the ESG evaluation module 3 filters the analysis result obtained by the text analysis module 2 (S103). For example, an item having the number of corresponding messages smaller than a predetermined threshold value is possibly noise, and hence the data on this item is removed to set the corresponding number of messages to 0. A condition of this filtering can be set by the user.

Next, the ESG evaluation module 3 cleanses the analysis result obtained by the text analysis module 2 (S104). For example, the ESG evaluation module 3 collates the message with a predetermined dictionary to remove personal information (a name, an address, a postal code, and the like) included in the message.

Next, the ESG evaluation module 3 weights the number of messages summed by the text analysis module 2 for each item (S105). For example, the ESG evaluation module 3 defines a coefficient k1 for each item in accordance with relevance between the ESG score being the evaluation index and the item. Moreover, the ESG evaluation module 3 defines a coefficient k2 in accordance with the certainty of the item (for example, in proportion to the certainty of the value of the item output from the machine learning model of the text analysis module 2). The coefficient may be determined in accordance with the number of messages in each item (for example, corresponding number of messages). After that, the analysis result obtained by the text analysis module 2 is weighted for each item through use of the following expression. It is preferred that k1 and k2 be numerical values between 1 to 0.

Number of messages for correlation calculation=k1×k2×number of messages in analysis result

Next, the ESG evaluation module 3 may execute processing such as removal of unnecessary columns, normalization, and conversion of data format (for example, matching a time in each time zone on the earth to a predetermined time (e.g., universal standard time)).

Next, the ESG evaluation module 3 calculates correlation between each number of messages corrected by the weighting and the ESG score (S106). Various methods exist for the calculation of the correlation, and it is preferred that a correlation coefficient be calculated by a statistical calculation method (for example, a method of dividing a covariance of the number of messages and the ESG score by a product of a standard deviation of the number of messages and a standard deviation of the ESG score).

Next, the output module 4 outputs the analysis result relating to the characteristic of the text set found from the analysis result of the texts and the calculated correlation (S107).

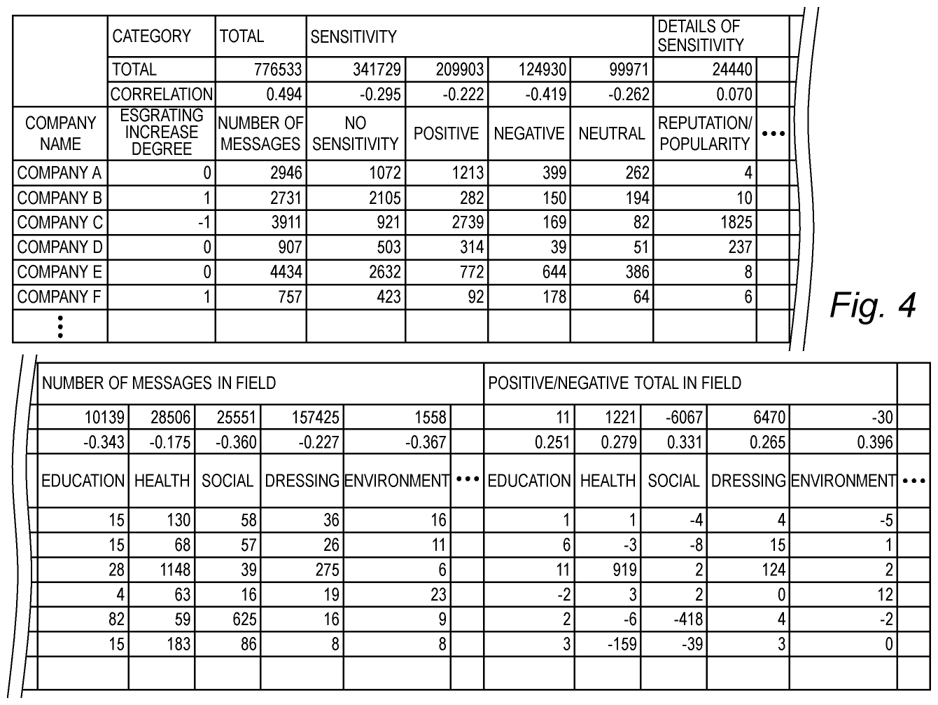

FIG. 4 is a diagram for illustrating sensitivity analysis data obtained by the ESG evaluation system 100 according to the embodiment of this invention analyzing the messages, and showing a result of the analysis of the messages of the SNSs input to the ESG evaluation system 100.

The data output from the ESG evaluation module 3 includes company names, the evaluation indices (ESG rating increase values), and the number of corresponding messages, a total number of messages, and a correlation value between the evaluation index and the item number for each item such as the number of messages, the analysis result of the sensitivity (number of tweets corresponding to each of no sensitivity, positive, negative, and neutral), details of the sensitivity (reputation/popularity and the like), the number of messages in field (education, health, social, dressing, environment, and the like), and a positive/negative total in field (the education, the health, social, the dressing, environment, and the like). It is preferred that the positive/negative total be calculated for items other than the shown items.

In the example of FIG. 4, the ESG rating increase value is used as the evaluation index. The ESG rating increase value is a change of a company or a country in ranking defined by a rating organization. As the evaluation index, in addition to the ESG rating increase value, when a company is target, a rating representing credibility of the company, a rating increase degree, the ESG score, an SDGs evaluation ranking, an SDGs evaluation ranking increase degree, or the like may be used. Moreover, when a local government is the target, the population increase rate, the hometown tax donation amount, or the like may be used.

The number of messages is the number of messages (for example, the number of messages of the SNSs) associated with this company in a target period. The result of the sensitivity analysis obtained by the text analysis module 2 is the number of messages labeled with each of the large categories being no sensitivity, negative, positive, and neutral. The details of sensitivity are the numbers of messages each labeled with each of small categories (reputation/popularity and the like) of the sensitivity. The number of messages in field is the number of messages labeled with each field by the result of the field analysis obtained by the text analysis module 2. The field is an index indicating the characteristics and the attributes of the company, and, for example, the five fields being education, health, social, dressing, and environment, which are the main viewpoints in the evaluation of the ESG score, are exemplified. Of those fields, “dressing” is a field meaning dress and ornament, and indicates a viewpoint relating to an aesthetic appearance of a person such as clothes, jewelries, beautification, and the like. The positive/negative total in field indicates a difference between the number of positive messages in the sensitivity and the number of negative messages in the sensitivity of the messages labeled with each field by the text analysis module 2. For example, the positive/negative total can be calculated by: “the number of positive messages in the sensitivity×1+the number of negative messages in the sensitivity×−1.”

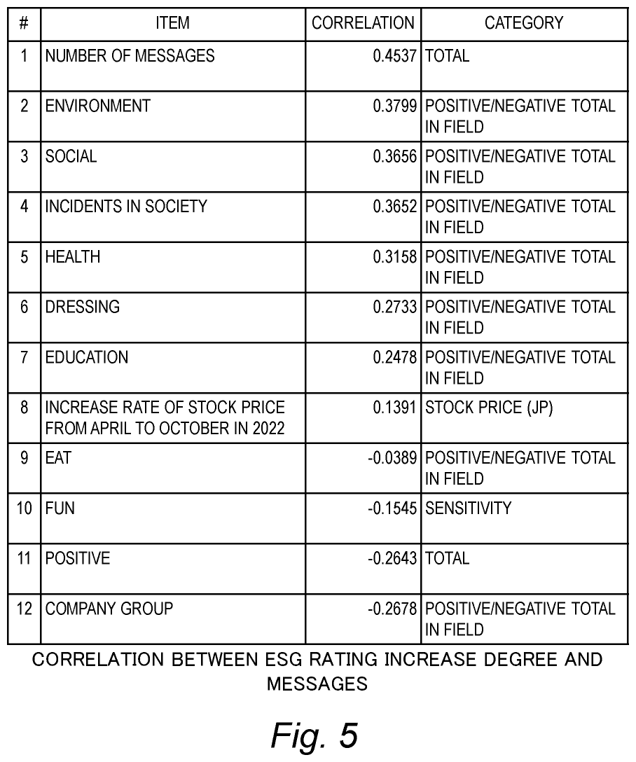

FIG. 5 is a diagram for illustrating sensitivity analysis data obtained by the ESG evaluation system 100 according to the embodiment of this invention analyzing the message.

The sensitivity analysis data of FIG. 5 shows items which are characteristic in the correlation with the ESG rating increase degree and are arranged in descending order of the correlation, and includes data on the item names, the correlation values, and the categories. It is preferred that the items of the sensitivity analysis data of FIG. 5 be obtained by extracting, by filtering, items each having a number that is equal to or larger than a predetermined number out of the numbers of the analysis result output by the text analysis module 2. Moreover, the items each having certainty of the value of the item which is output from the machine learning model of the text analysis module 2 and is equal to or higher than a predetermined threshold value may be extracted by filtering. The correlation value is set such that +1 indicates high positive correlation, −1 indicates high inverse correlation, and 0 indicates no correlation. Based on the sensitivity analysis data of FIG. 5, items to be managed to increase or prevent a decrease in the evaluation index (ESG rating increase degree) are found, and a guideline for planning actions of the company or the local government is acquired. Specifically, items relating to the ESG have high correlation, and items in the category of the positive/negative total in field have high correlation. Thus, it is found that the correlation between the evaluation in the fields relating to the ESG and the ESG rating is high. This result can be used for a model for estimating the ESG rating increase degree. Moreover, it is possible to examine appropriateness of the ESG rating of a company by comparing such analysis results of the correlation among a plurality of companies.

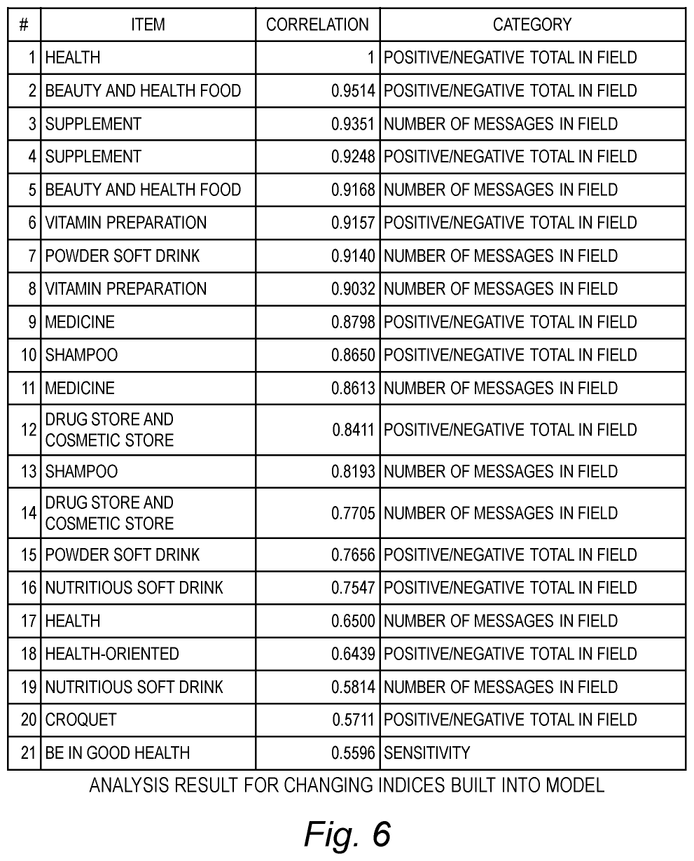

FIG. 6 is a diagram for illustrating sensitivity analysis data analyzed from the message by the ESG evaluation system 100 according to the embodiment of this invention.

The sensitivity analysis data of FIG. 6 shows an arrangement of items in descending order of the correlation with the evaluation index, and includes data on the item names, the correlation values, and the categories. Based on the sensitivity analysis data of FIG. 6, it is possible to acquire indices for the ESG evaluation module 3 to select items used to calculate the correlation.

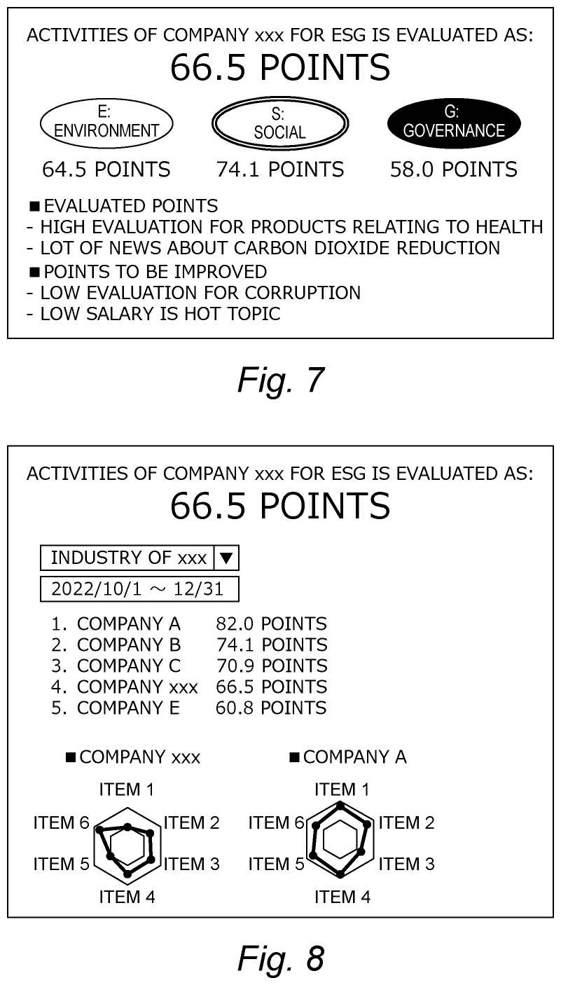

FIG. 7 is a diagram for illustrating an output example of the ESG evaluation system 100 according to the embodiment of this invention.

The output example of FIG. 7 indicates summary information to be displayed on a screen, and is a display screen example including the ESG score of a relevant company, scores in each of viewpoints of environment, social, and governance, evaluated points which contribute to an increase in score, and points to be improved which cause a decrease in score. It is preferred that the ESG score be calculated as a value obtained by summing the number of messages relating to the ESG, normalizing the sum together with the sums of other companies, and multiplying the resultant by 100. Moreover, the ESG score may be calculated also as a value obtained by summing the number of positive/negative totals relating to the ESG, normalizing the sum together with the sums of other companies, and multiplying the resultant by 100. Moreover, the ESG score may be calculated by using both of the number of messages and the positive/negative total (for example, by using a total of values each obtained by normalizing and then multiplying the resultant by 50). In general, the item having the value used to calculate the ESG score has high positive or inverse correlation with the ESG score. Similarly, it is preferred that the score of each of environment, social, and governance be calculated as a value obtained by summing the positive/negative totals each in each of the fields of environment, social, and governance, normalizing the sum together with the sums of other companies, and multiplying the resultant by 100. Moreover, as evaluated points and points to be improved, it is preferred that messages prepared in advance be displayed in correspondence to ESG scores and scores of environment, social, and governance.

FIG. 8 is a diagram for illustrating an output example of the ESG evaluation system 100 according to the embodiment of this invention.

The output example of FIG. 8 indicates information on comparison with other companies displayed on the screen, and is a display screen example including an ESG score of the relevant company, ESG scores of other companies, and radar charts of numbers of messages in items to be focused on. Based on the output example of FIG. 8, it is possible to visualize strong points and weak points of the own company compared with the other companies. Moreover, the user can check a position of the own company in the own industry by switching an industry being the comparison target. Moreover, it is possible to check a position of the own company in another industry.

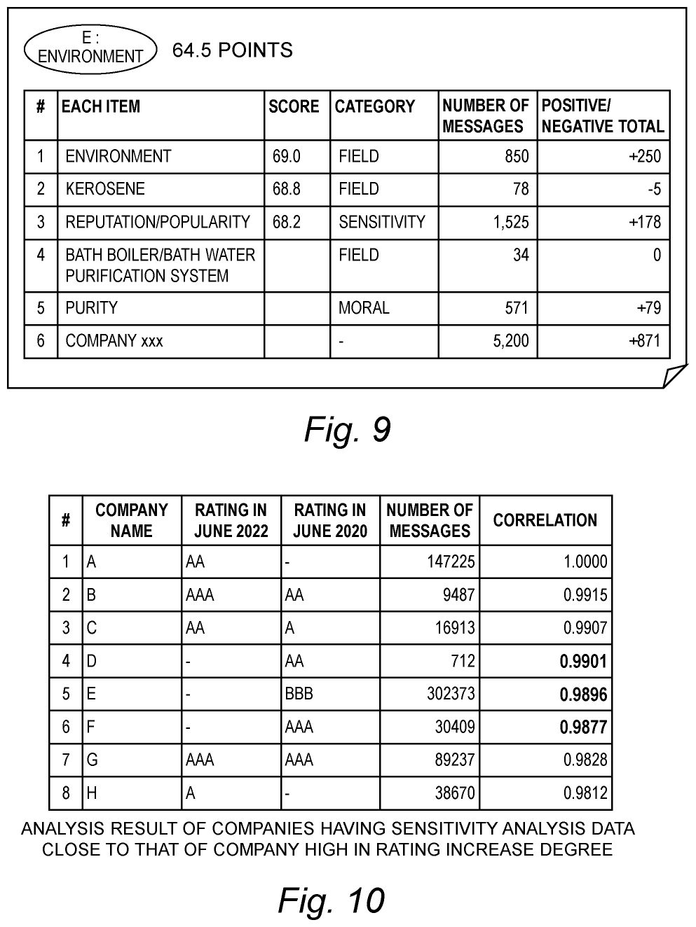

FIG. 9 is a diagram for illustrating an output example of the ESG evaluation system 100 according to the embodiment of this invention.

The output example of FIG. 9 indicates details of evaluation relating to environment, and is an example of a printed matter including the ESG score of each of items relating to environment, categories of the items, the numbers of messages of the items, and negative and positive total values of the items. In the output example of FIG. 9, the number of messages and a positive/negative total categorized to each item are displayed together as one category on one line, to thereby display a list of scores of items forming a basis of the score of environment. It is preferred that scores of items forming a basis of the ESG score be displayed while switching to social or governance in addition to environment.

In the output example of FIG. 9, an example in which the score is calculated through use of both of the number of messages and the negative/positive total value is shown, but the score may be calculated through use of one of the number of messages or the negative/positive total value as described above.

FIG. 10 is a diagram for illustrating an output example of the ESG evaluation system 100 according to the embodiment of this invention.

The output example of FIG. 10 is an example of external cooperation data including data on changes in rating, changes in SDGs ranking, the numbers of messages, and correlation. The correlation included in the output example of FIG. 10 is calculated from an analysis result of a certain company (company A) and analysis results of other companies, and indicates similarity between the analysis result of the company A and the analysis results of the other companies. Thus, it is possible to acquire companies similar in analysis result to the company A through search. In the output example of FIG. 10, a company D, a company E, and a company F can be selected as companies having sensitivity analysis data close to that of the company A.

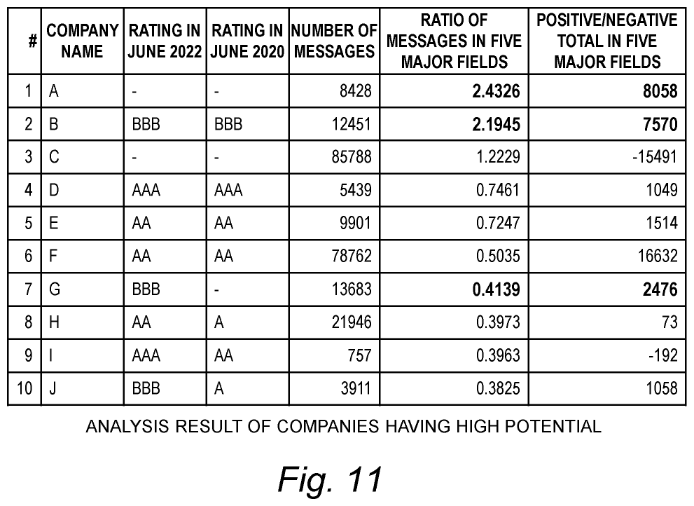

FIG. 11 is a diagram for illustrating an output example of the ESG evaluation system 100 according to the embodiment of this invention.

The output example of FIG. 11 includes changes in rating, changes in SDGs ranking, the numbers of messages, ratios of messages in five major fields, and positive/negative totals in the five major fields. Thus, companies to which the analysis by the ESG evaluation system 100 according to the at least one embodiment suits are recognized. Based on the output example of FIG. 11, a relationship between the change in rating and another index can be analyzed, and hence a company having high potential can be acquired through search. Moreover, the company A and the company B each having a high ratio of the messages in the five major fields and a company G having a large positive/negative total in the five major fields can be selected as companies to which the analysis by the ESG evaluation system 100 suits.

FIG. 10 and FIG. 11 are described as the external cooperation data to be output to another system, but may be output as screens as illustrated in FIG. 7 and FIG. 8, or may be output as printed matters as illustrated in FIG. 9.

As described above, according to the at least one embodiment of this invention, the social value included in the messages can appropriately be evaluated. Moreover, a company and a local government can be evaluated in consideration of the sensitivity of potential stakeholders (for example, SNS users and residents) of the company and the local government. Further, a rating method used by the rating company is a black box, but an organization having a close rating and an organization having a high rating can be analyzed based on the values of the items analyzed by this system. As a result, a guideline for planning actions of a company and a local government can be obtained.

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, processing modules, and processing means, for all or a part of them, may be implemented by hardware: for example, by designing an integrated circuit, and may be implemented by software, which means that a processor interprets and executes programs providing the functions.

The information of programs, tables, and files to implement the functions may be stored in a storage device such as a memory, a hard disk drive, or an SSD (a Solid State Drive), or a storage medium such as an IC card, or an SD card.

The drawings illustrate control lines and information lines as considered necessary for explanation but do not illustrate all control lines or information lines in the products. It can be considered that almost of all components are actually interconnected.

What is claimed is:

1. An evaluation system for evaluating a predetermined index based on an input message being input text information, the evaluation system comprising:
a calculation unit configured to execute calculation processing; and
a storage unit accessible from the calculation unit,
the calculation unit including:
an analysis module configured to analyze the input message through use of a model that adds a label of sensitivity to the input message, to thereby categorize the input message; and
an evaluation module configured to calculate correlation between a numerical value of each item included in a result of the analysis obtained by the analysis module and a predetermined index value.

2. The evaluation system according to claim 1, wherein the analysis module is configured to analyze the input message through use of a model that adds a label of a field to the input message, to thereby categorize the input message.

3. The evaluation system according to claim 1, wherein the predetermined index is an ESG score.

4. The evaluation system according to claim 3, wherein the evaluation module is configured to calculate the ESG score from a result of the analysis obtained by the analysis module to output the calculated ESG score.

5. The evaluation system according to claim 4, wherein the evaluation module is configured to calculate the ESG score of each of a plurality of companies from a result of the analysis obtained by the analysis module to output data enabling comparison among the calculated ESG scores of the plurality of companies.

6. The evaluation system according to claim 1, wherein the evaluation module is configured to output, among items labeled with a word representing the sensitivity, an item having a value forming a basis for calculating the predetermined index.

7. The evaluation system according to claim 1,
wherein the analysis module is configured to:
categorize the input message in accordance with whether the sensitivity is positive or negative; and
calculate, for each item, a positive/negative total value obtained by subtracting the number of messages each having negative sensitivity from the number of messages each having positive sensitivity, and
wherein the evaluation module is configured to output, among the calculated positive/negative total values, an item that forms a basis for calculating the predetermined index.

8. The evaluation system according to claim 1, wherein the evaluation module is configured to select and output evaluation targets similar in tendency of the number of messages labeled by the analysis.

9. The evaluation system according to claim 1, wherein the analysis module is configured to analyze the input message through use of a model that adds a label of a moral to the input message, to thereby categorize the message.

10. An evaluation method of evaluating, by an evaluation system, a predetermined index based on an input message being input text information,
the evaluation system including: a calculation unit configured to execute calculation processing; and a storage unit accessible from the calculation unit,
the evaluation method comprising:
an analysis step of analyzing, by the calculation unit, the input message through use of a model that adds a label of sensitivity to the input message, to thereby categorize the input message; and
an evaluation step of calculating, by the calculation unit, correlation between a numerical value of each item included in a result of the analysis obtained in the analysis step and a predetermined index value.
